(19) United States
(12) Patent Application Publication
(10) Pub. No.: US 2024/0139668 A1
(43) Pub. Date: May 2, 2024

(54) SMART DUST SUPPRESSION SYSTEM THAT SPRAYS ATOMIZED WATER THROUGH A FAN

(71) Applicant: ENVEKS PAZARLAMA TOZ INDIRGEME SISTEMLERI LIMITED, Kazan/Ankara (TR)

(72) Inventor: Hasan SARIGÜL, Çankaya, Ankara (TR)

(21) Appl. No.: 18/549,131

(22) PCT Filed: Mar. 9, 2021
(86) PCT No.: PCT/TR2021/050208

§ 371 Date: Sep. 5, 2023

(51) Int. Cl. B01D 47/06; E21F 5/02

(52) U.S. Cl. CPC B01D 47/06; E21F 5/02

(57) ABSTRACT

Disclosed is a smart dust suppression system that sprays atomized water through a fan that ensures the dust raised during collection, transport and discharge to be suppressed at the point where it starts to form without spreading to the environment, in enterprises such as cement factories, iron and steel factories, coal enterprises, thermal power plants, ports and the like, in machines that ensure the stockpiling of raw materials and the recovery of the stocked raw materials in all open and closed mine sites, in clamshell and conveyor belt systems, thereby preventing environmental pollution, protecting human health, preventing machinery and equipment from being affected by dust, and suppressing the dust emitted by the conveyor belts and the clamps during the unloading of the raw material.

### TECHNICAL FIELD OF THE INVENTION

The present invention relates to a smart dust suppression system that sprays atomized water through a fan, which ensures that the dust raised during collection, transport and discharge to be suppressed at the point where it is formed without spreading to the environment in enterprises such as cement factories, iron and steel factories, coal enterprises, thermal power plants, ports and the like, in machines that ensure the stockpiling of raw materials and the recovery of the stocked raw materials in all open and closed mine sites, in clamshell and conveyor belt systems, thereby prevents environmental pollution, protects human health, prevents machinery and equipment from being affected by dust, suppresses the dust emitted by the conveyor belts and the clamps during the unloading of the raw material by automatically or manually adjusting the spray angle according to the pouring height of the raw material, by spraying atomized water to the first point of the dust, without spreading the same to the environment and sprays atomized water with fan.

### STATE OF THE ART

In the state of the art, the dust suppression systems used to suppress dust that is raised when collecting, transporting, and discharging in machines that enable the stock of raw materials in the mine sites and the recovery of the stocked raw materials, in clamshell and conveyor belt systems, try to control dust by means of spraying after the dust is spread to the environment with single or double fluid nozzles or with atomized water systems with a fan placed on the platform sequentially along the length of the stockyard where the raw material is stored, collected, or close to the area where the dust problem occurs. Among these systems, nozzles that are used in single and double fluid systems do not have a very long spraying range, since they do not suppress the dust of the spilled raw material during spilling from an elevated point; they are not preferred in stacker and reclaimer applications. Although said systems are preferred, they cannot suppress the dust at the desired international rates.

In the state of the art, in enterprises such as cement factories, iron and steel factories, mine stockpiles, thermal power plants, ports, etc., for stocked raw materials in open or closed areas, stacker systems, reclaimer systems are used to collect the raw material from the stock area and send the same to the process, bunkers loaded with the clampshell bucket, and clamshell bucket cranes, and to load the raw material into carrier vehicles such as trucks and wagons.

Once the systems used during stocking, collection, loading, and transportation of raw materials begin operating, the raw material begins moving, thereby forming and raising dust. The movement of the raw material occurs by taking the raw material from one place, transferring the same, and leaving the same to another. Various systems are used during receiving, transferring, and releasing processes of raw materials, and every time the raw material moves, there is a risk of dust formation.

The dust suppression systems and equipment in the state of the art that are used for suppressing the dust formed in enterprises and areas where there is the risk of dust formation, serve for controlling the dust after it spreads to the environment. Said systems are used only when the raw materials are being received and released, and cannot be programmed according to the amount of raw material and dust, the first point where the dust begins spreading to the environment, and the volume of the dust. In this case, the formed dust cannot be suppressed sufficiently, and the negative effects of the dust cannot be eliminated in its entirety. Moreover, dust reduction systems and equipment used in the state of the art require constant human intervention due to the change of location and volume of the raw material.

### OBJECTS OF THE INVENTION

The present invention aims to minimize the risk of dust formation by keeping the raw material under constant control and areas where the raw material moves during the processes of receiving raw materials, transferring and placing them with various systems in enterprises and in areas where there is a risk of dust formation, and thus aims to prevent environmental pollution, to protect human health, and to prevent machinery and equipment from being affected by dust.

Moreover, the present invention can control dust not only in one part of the worksite but in the entire area since the invention is applicable to all systems used for the transport/transfer of raw materials and is capable of adjusting its position according to the changing volume of the raw material and the first point where the dust begins to dissipate.

Furthermore, the present invention can supply uninterrupted water with an automatic hose reel so as to prevent any shortage during dust control, or water supply can be provided with an external water tank to be mounted on movable systems.

Moreover, the invention can adjust the fan airflow, water flow, and pressure based on the water spraying range, regarding to dust formation rate, material capacity and pouring height of the raw material.

### DESCRIPTION OF THE FIGURES

FIG. 1 illustrates the view of the manner in which the present invention is applied to the lineer stacker system.

FIG. 2 illustrates the view of the manner in which the present invention is applied to tripper car.

FIG. 3 illustrates the view of the application of the present invention to the raw material reclaimer system.

FIG. 4 illustrates the view of the application of the present invention to the bunker loaded with the clamshell bucket.

FIG. 5 illustrates the view of the application of the present invention to the clamshell bucket crane.

### DESCRIPTION OF THE REFERENCES IN THE FIGURES

The equivalents of the reference numbers shown in the figures are given below.
1. Automatic Hose Reel
2. Atomized Water Spraying Fan

### DESCRIPTION OF THE INVENTION

The inventive smart dust suppression system that sprays atomized water with the fan consists of two basic components: an automatic hose reel (1) or an external water tank, and an atomized water spraying fan (2).

Atomized water spraying fan (2) suppresses the dust at its source by spraying water mist to the dust generated by the movement of the raw material or by the wind at points where the raw material is taken, transferred from one point to another point on the belt and left/poured/stocked. The automatic hose reel (1) automatically opens and collects the supply hoses and provides continuous water to the atomized water spraying fan (2). Thus, there is no need for a water tank and resupplying said water tank with water. Moreover, in another embodiment of the present invention, an external water tank that is mounted on moving systems where the present invention is to be applied and supplies water to the atomized water spraying fan (2) can be used instead of the automatic hose reel (1).

The atomized water spraying fan (2) has a movement sensor that calculates the pouring height of the raw material during the pouring of the raw material into the stock. Said movement sensor calculates the pouring height of the raw material in order to suppress the dust that comes out during the pouring of the raw material into the stock in the best way possible and allows the atomized water spraying fan (2), which moves up-down and left-right according to constantly changing height, to precisely target the section where the dust comes out.

The position of the atomized water spraying fan (2) can be adjusted both manually and automatically by means of the movement sensor.

The atomized water spraying fan (2) has another material sensor that detects whether there is a raw material on the belt on which the raw material is transferred. Dust is formed again while the raw material is transferred from one point. When there is raw material on the belt, said material sensor activates the atomized water spraying fan (2) and suppresses the dust, when there is no raw material on the belt, it turns off the atomized water spraying fan (2) and prevents it from running idle. The fan spraying systems mounted on the conveyor belts on the stacking and reclaiming machines due to high current draw of the drive drum when there is material on the belt with the flow circuit automation operating with the flow information received from the drive drum motor feed phase is activated and are deactivated due to low current draw when there is no material on the conveyor belt.

Atomized water spraying fan (2) has a fan speed control system. The fan speed control system adjusts the airflow rate of the atomized water spraying fan (2) according to the property of water spraying distance of the atomized water spraying fan (2) and dusting of the material. The fan speed control system allows the spraying distance setting to be the most effective distance setting according to the area where the dust comes out.

Water flow rate and pressure can be adjusted with the speed control system and water regulator on the water pump connected to the atomized water spraying fan (2).

The present invention can be used in all enterprises and fields where there is a risk of dust formation. The present invention is applicable to all points where the raw material having dust formation risk is transferred, of all systems such as stacker systems used for stocked raw materials in open or closed areas, reclaimer systems used to collect the raw material from the stock area and send it to the process, bunkers loaded with the clampshell bucket and clamshell bucket cranes, etc. used to load the raw material on carrier vehicles such as trucks and wagons. Therefore, dust is taken under control in all regions where there is a risk of dust formation, and all negative effects caused by dust are minimized.

Examples of the application methods of the smart dust suppression system that makes atomized water spraying with fan subject to registration to different systems are as follows.

Lineer Stacker System (Type 1): In the Lineer Stacker System (Type 1) shown in detail in FIG. 1, atomized water spraying fan (2) is mounted at the transfer and pouring points of the raw material on the conveyor belt. Atomized water spraying fan (2) located under the boom of the moving conveyor belt stocker system (type 1), targets the section where the dust comes out by moving up-down and left-right according to the pouring height of the material so as to suppress the dust that comes out during the pouring of the material into the stock. The up-down and right-left movement of the atomized water spraying fan (2) located under the boom, fan spraying distance according to the movement angle, and the pouring height of the raw material (electric motor speed control) can be adjusted automatically or manually by means of a sensor, software or logic control. Therefore, the spraying can be adjusted according to the section where the dust comes out.

The atomized water spraying fan (2) under the boom is for supporting purposes during the pouring of the atomized water spraying fan (2) on the boom end spill point on the Lineer Stacker System (Type 1), it ensures to suppress the dust while the raw material is poured on the stock. The up-down and right-left movement angle of the atomized water spraying fan (2) located on the boom, can be adjusted automatically or manually by means of a sensor, software, or logic control that adjust the fan spraying distance (electric motor speed control) according to the pouring height of the raw material. Therefore, the spraying can be adjusted according to the section where the dust comes out.

The atomized water spraying fan (2) on the top and in the middle portion of the boom on the Lineer Stacker System (Type 1) is used to suppress the dust generated by the wind in the stock area. The top of the stock area is moistened, and the dust caused by the wind is prevented by the up-down and left-right movement of the atomized water spraying fan (2). The atomized water spraying fan (2) located at the transfer point from the belt feeding the boom belt to the belt on the Lineer Stacker System (Type 1) provides suppressing the dust that occurs when the material is poured on the boom belt. All atomized water spraying fans (2) on the Lineer Stacker System (Type 1) can operate both automatically and manually by moving up-down and left-right and can also operate in one direction according to the operation.

The water need of all atomized water spraying fans (2) on the Lineer Stacker System (Type 1) are met by the automatic hose reel (1) that provides continuous water to the atomized water spraying fan (2) by automatically opening and collecting the supply hoses installed on the system or an external water tank.

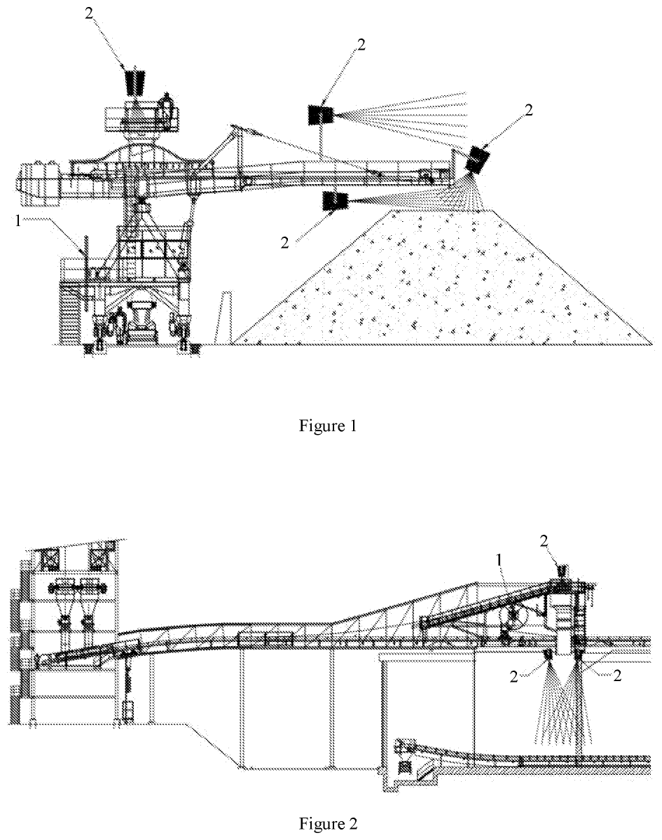

Tripper Car System (Type 2): In the tripper car system (Type 2) shown in detail in FIG. 2, atomized water spray fans (2) are mounted on the transfer point on the moving belt and the belt transfer point and discharge chutes so as to suppress the dust that comes out during pouring into the stock. All atomized water-sprayed fans (2) on the tripper car system (Type 2) can move up-down and left-right, also they can perform spraying in one direction depending on the operation. In tripper car system (Type 2), the atomized water spraying fan (2) located under the conveyor belt discharge chute aims to suppress the dust that comes out during pouring into the stock, the up-down and right-left movement of the material according to the pouring height, fan spraying distance according to the movement angle and the pouring height of the raw material (electric motor speed control) can be adjusted automatically or manually by means of a sensor, software or logic control. Therefore, the spraying can be adjusted according to the section where the dust comes out.

The water need of all atomized water spraying fans (2) on the tripper car system (Type 2) is met by the automatic hose reel (1) that provides continuous water to the atomized water spraying fan (2) by automatically opening and collecting the supply hoses installed on the system or an external water tank.

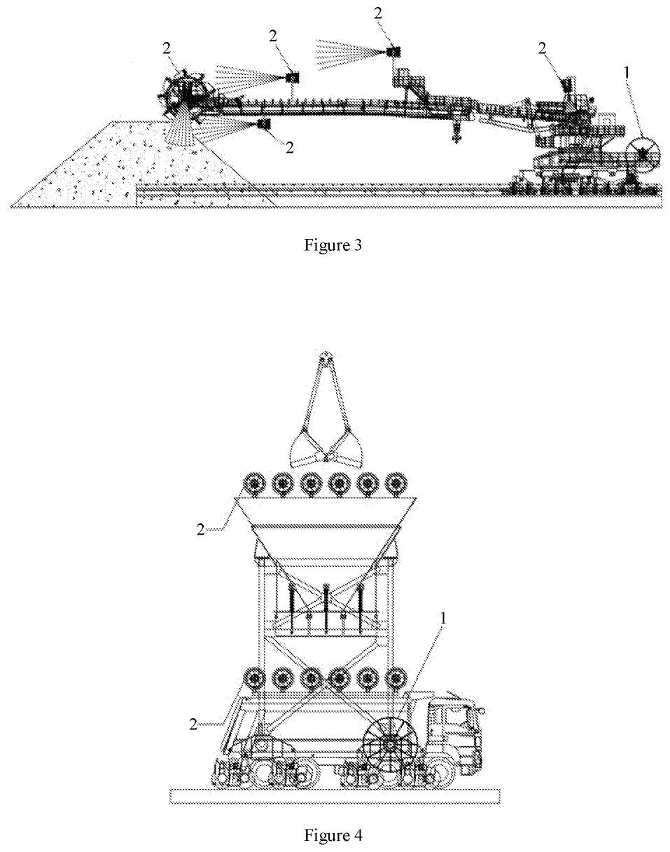

Raw Material Reclaimer System: An atomized water spraying fan (2) is assembled so as to suppress the dust that comes out in these systems whose detailed view is shown in FIG. 3. In the raw material reclaimer system, while the atomized water spray fan (2) mounted on the boom ensures that the raw material is taken from the stock with buckets and the dust released during the pouring into the conveyor belt is suppressed, on the other hand, other atomized water spraying fans (2) ensure that the dust that will be formed by the wind on the bulk material in the stock is suppressed, the dust coming out of the first transfer point is suppressed during the material retrieval of the buckets from the stock and after the material taken from the stock with the buckets is taken to the conveyor belt.

The atomized water spray distance of fans and the fan airflow rate according to the dusting feature of the material can be adjusted by means of the speed control system located on the atomized water spraying fans (2) located above and below the system in raw material reclaimer systems. The fan speed control system allows the spraying distance setting to be the most effective distance setting according to the area where the dust comes out. Water flow rate and pressure can be adjusted with the speed control system and water regulator on the water pump.

The water need of all atomized water spraying fans (2) on the raw material reclaimer system are met by the automatic hose reel (1) that provides continuous water to the atomized water spraying fan (2) by automatically opening and collecting the supply hoses installed on the system or an external water tank.

Bunker Loaded With The Clamshell Bucket: In bunkers loaded with the clamshell bucket shown in detail in FIG. 4, the atomized water spraying fans (2) arranged sequentially on the bunker ensure that the dust rising during the discharge of the raw material into the bunker is suppressed inside the bunker without spreading to the environment, during loading onto vehicles such as trucks, wagons, etc. with the clamshell bucket loader over the bunker. Moreover, atomized water spray fans (2) are placed under the bunker sequentially so as to suppress the dusting rising from the raw material that is poured into the vehicle during raw material loading to be made to the vehicles such as truck, wagon, etc. when the clamp under the bunker opens. Bunkers loaded with clamshell buckets move on the rails or are stationary in areas such as mines, port areas, etc. For this reason, an automatic hose reel (1) or an external water tank is mounted on the bunker so as to supply water constantly to the atomized water spraying fans (2) that will provide dust suppression on and under the bunker. The dust suppression system starts to spray water with automatic up-down and right-left movement angle or with a fixed motion with the sensor placed on the bunker seeing the material or the clamshell, the system can also be operated manually.

The atomized water spray distance of fans and the airflow rate can be adjusted according to the dusting feature of the material by means of the speed control system located above the atomized water spraying fans (2) on and under the bunker in bunkers loaded with clamshell bucket. The fan speed control system allows the spraying distance setting to be the most effective distance setting according to the area where the dust comes out. Water flow rate and pressure can be adjusted with the speed control system and water regulator on the water pump.

The water need of all atomized water spraying fans (2) on bunkers loaded with clamshell bucket is met by the automatic hose reel (1) that provides continuous water to the atomized water spraying fan (2) by automatically opening and collecting the supply hoses installed on the system or an external water tank.

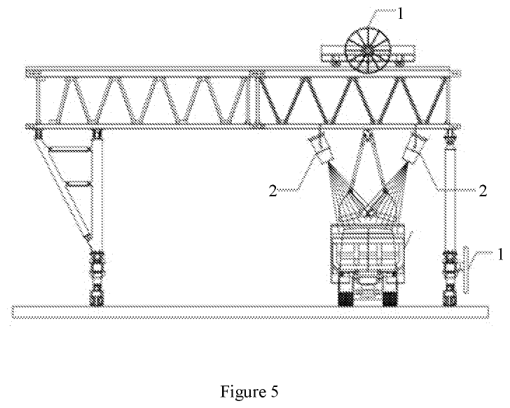

Clamshell Bucket Cranes: In clamshell bucket cranes shown in detail in FIG. 5, the atomized water spray fans (2) on both sides of the clamshell bucket are designed to suppress the dust rising during the pouring of the raw material in loadings made with vehicles such as the clamshell bucket loader on trucks, wagons and so on. It can be adjusted automatically or manually by means of sensor and software or logic control, according to the pouring height of the material, the movement angle of up-down left-right.

Therefore, the spraying can be adjusted according to the section where the dust comes out.

The atomized water spray distance of fans and the fan airflow rate according to the dusting feature of the material can be adjusted by means of the speed control system located on the atomized water spraying fans (2) on the crane, in clamshell bucket cranes. The fan speed control system allows the spraying distance setting to be the most effective distance setting according to the area where the dust comes out. Water flow rate and pressure can be adjusted with the speed control system and water regulator on the water pump.

The water need of all atomized water spraying fans (2) used in the clamshell bucket cranes is met by the automatic hose reel (1) that provides continuous water to the atomized water spraying fan (2) by automatically opening and collecting the supply hoses installed on the system or an external water tank.

### INDUSTRIAL APPLICABILITY OF THE INVENTION

The present invention can be used in all enterprises such as cement factories, iron and steel factories, mine stockpiles, thermal power plants, ports, etc. with a high risk of dust formation and all carrier systems such as conveyor belt, bunker, crane, etc. used during the operations of stocker of raw materials, collection to the process, loading, transportation and so on in open and closed fields so as to suppress the dust at its source and during its spreading to the environment.

1. A smart dust suppression system that makes atomized water spraying with a fan that ensures the dust occurring during collection, transport and discharge to be suppressed at the point where it starts to form without spreading to the environment in enterprises such as cement factories, iron and steel factories, coal enterprises, thermal power plants, ports and the like, in machines that ensure the stockpiling of raw materials and the recovery of the stocked raw materials in all open and closed mine sites in clamshell and conveyor belt systems, thereby prevents environmental pollution, protects human health, prevents machinery and equipment from being affected by dust, suppresses the dust emitted by the conveyor belts and the clamps during the unloading of the raw material by automatically or manually adjusting the spray angle according to the pouring height of the raw material, by spraying atomized water to the first point of the dust, without spreading the same to the environment, sprays atomized water with fan, wherein the system
comprises:
an atomized water spraying fan that suppresses the dust at its source by spraying water mist to the dust generated by the movement of the raw material or by the wind at all points where the raw material is taken, transferred from one point to another point on the belt and left/poured/stocked,
at least one movement sensor that calculates a pouring height of the raw material in order to suppress the dust that comes out during the pouring of the raw material into the stock in the best way and allows the atomized water-jet fan, which moves up-down and left-right according to constantly changing height, to precisely target the section where the dust comes out,
an electric motor speed control, sensor, software, or logic control that automatically adjusts the spraying distance of the atomized water spray fan based on the pouring height of the raw material,
a material sensor that detects whether the raw material is present on the belt where the raw material is transported and activates or deactivates the atomized water spraying fan accordingly, so as to suppress the dust that comes out during the transfer of the raw material from one point to another on the belt, and
the feature of automated activation of the atomized water spray fans mounted on the conveyor belts on the stocker and collecting machines due to high current draw of the drive drum when there is material on the belt with the flow circuit automation operating with the flow information received from the drive drum motor feed phase and deactivation due to low current draw when there is no material on the conveyor belt.

2. Smart dust suppression system that makes atomized water spraying with fan according to claim 1, comprising:
an automatic hose reel that provides continuous water to the atomized water spraying fan by automatically unwinding and collecting the supply hoses supplying water to the atomized water spraying fan and that eliminates the need for any water tank and supply of said water tank or
an external water tank that is mounted on the moving systems where the invention is to be applied and that supplies water to the atomized water spraying fan.

3. Smart dust suppression system that makes atomized water spraying with fan according to claim 1, wherein is applicable to all points where the raw material with dust formation risk is transferred, of all systems such as stacker systems used for stocked raw materials in open or closed areas, raw material reclaimer system used to collect the raw material from the stock area and send it to the process, bunkers loaded with the clampshell bucket and clamshell bucket cranes, etc. used to load the raw material on carrier vehicles such as trucks and wagons.

4. Atomized water spraying fan according to claim 1, wherein the atomized water spraying fan that provides the most effective water spraying distance adjustment according to the area where the dust occurs, comprises a fan speed control system that adjusts the airflow rate of the atomized water spraying fan according to the property of water spraying distance and dusting of the material.

5. Atomized water spraying fan according to claim 1, comprising a water speed control system and water regulator located on the water pump connected to the atomized water spraying fan that regulates the flow rate and pressure of the sprayed water.

6. Atomized water spraying fan according to claim 1, wherein it can be controlled automatically or manually by means of its sensors.
